(19) United States
(12) Patent Application Publication
(10) Pub. No.: US 2009/0278789 A1
(43) Pub. Date: Nov. 12, 2009

(54) SCANNING BACKLIGHT COLOR CONTROL

(76) Inventors: Bjorn DECLERCQ, Wattrelos (FR); Jeroen Debonnet, Marke (BE); Kristiaan De Paepe, Gent (BE)

Correspondence Address: BACON & THOMAS, PLLC, 625 SLATERS LANE, FOURTH FLOOR, ALEXANDRIA, VA, 22314-1176, US

(21) Appl. No.: 12/420,542

(22) Filed: Apr. 8, 2009

(30) Foreign Application Priority Data
Apr. 9, 2008 (EP) 08154288.8

(51) Int. Cl. G09G 3/36

(52) U.S. Cl. 345/102

(57) ABSTRACT

A scanning backlight (70) for a display, the backlight having a number of sections separately illuminated, a controller (20) to control the illuminating of the different sections at different times, and to control relative luminance levels of the different sections, and the backlight having a sensor (60) to detect a spectrum of the lighting, the controller being arranged to control a color of the illuminations of the different sections according to the detected spectrum. This combination can enable the color output to be maintained accurately without needing an external spectrometer, and control the uniformity of color in the different sections. This control can enable the specifications of any parts used to illuminate the sections to be relaxed, such as temperature and aging specifications, to keep the costs lower.

### FIELD OF THE INVENTION

This invention relates to backlights for panel displays such as liquid crystal devices and to corresponding systems and methods.

### DESCRIPTION OF THE RELATED ART

A reference monitor needs to have a very high luminance and color uniformity over the entire screen area, as well as a wide, controllable and stable color gamut (well defined color triangle). The last requirement leads to the use of R-G-B LED light sources in the backlight.

But in order to get a uniform white light output over the entire screen starting from the discrete red, green and blue point-like light sources, one has to incorporate long optical mixing lengths. This leads to a display with a large depth. In a practical situation not more than approximately 50 mm is available for the complete backlight assembly, so this is also the largest available mixing length. This mixing length is hardly sufficient to arrive at the required color uniformity.

Another specification of a reference monitor is the ability to visualize in a natural way fast movements, without showing motion blur or other motion artifacts. Due to the hold-type representation of images on a LCD screen, motion artifacts will be visible. A possible solution to avoid these artifacts is using a scanning type backlight, composed of a certain number of separately lit sections, typically in the form of horizontal light trays. Each of these trays is illuminated individually, and is optically isolated from its neighbouring trays. These trays are illuminated time sequentially in synchronisation with the addressing of the LCD rows, in such a manner that the slow response of the LCD liquid crystal cells is masked by occurring during the dark (non illuminated) time zones. But such backlight scanning has not been widely used in high end applications as it increases complexity, can introduce more unwanted artifacts and reduces dimming range.

The intensity output of some light sources, in particular of solid state light sources, such as LEDs, can vary according to factors such as temperature and age. Consequently, conventional LED based backlights and others do not reliably maintain a desired intensity and/or colour during their lifetime. In a typical multi-colour based backlight, e.g. RGB backlight, a plurality of optical sensors, e.g. 3 in the case of RGB backlight, are based in the backlight cavity. Bach optical sensor is read out by a control device that compensates the drive settings to the correct or desired white point, based on the read out luminance values. Typically, the three optical sensors are placed in one package and have a given spectral response. Because the colour filters of the optical sensors are overlapping, there is an influence of the other colours during readout. For example, if one reads out GREEN, also a part of RED and BLUE is in the end result. It can be seen that, when RED is switched off while GREEN is still on, the red sensor will still sense some light, i.e. that part of the GREEN which is in the wavelength range detectable by the red sensor. In typical systems, the LEDs are driven by PWM, and sensor values are integrated to DC for measurements. This results in very slow response times and if high dimming ratio is required also results in high resolution and expensive A/D converters being required. An LED-based luminaire is known from WO 2006/014473, which includes an emitter module having one or more LEDs and a regulating device that regulates the current delivered to the emitter module. The luminaire may include an optical sensor that measures the LED radiant output, and a controller that uses the detected output to control the regulating device based on the measured output, in order to maintain a consistent colour and/or intensity level. The LED-based luminaire may incorporate one or more colour channels, and the optical sensor may produce an intensity output for each colour corresponding to the colour channels. The sensor may be a single integrated circuit device which is capable of detecting multiple colour channels, if each colour is driven separately sequentially.

WO 2006/0290624 shows a backlight with RGB LEDs, and a colour sensor for detecting and feeding back chromaticity and colour intensity for use in controlling the relative drive levels of the single set of RGB LEDs to maintain a desired colour of the overall display. LED junction temperature is also monitored.

### SUMMARY OF THE INVENTION

An object of the invention is to provide backlights for panel displays such as liquid crystal devices and corresponding systems and methods. According to a first aspect, the invention provides:

A scanning backlight for a display, the backlight having a number of sections separately illuminated, a colour sensor to detect a spectrum of the lighting, and a controller in order to control the illuminating of the different sections at different times, relative luminance level of each of the different sections, and a colour of the illuminations of the different sections according to the detected spectrum.

This combination can enable the colour output to be maintained more accurately than relying on sensing luminance values of individual colour sources, which gives little indication of spectral shift for example. It is particularly useful to be able to accomplish this where there are sections separately illuminated, without needing an external spectrometer. As the sections are separately illuminated, the uniformity of colour in the different sections can be controlled as desired. Such control can enable the specifications of any parts used to illuminate the sections to be relaxed, such as temperature and aging specifications, which can keep the costs lower. This becomes more important as the number of sections increases. Furthermore it can help enable real time measurement of individual LED-groups without hindering display function. Embodiments of the invention can have any other features added, some such additional features are set out in dependent claims and described in more detail below.

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows an embodiment showing a backlight incorporated in a display,

FIG. 2 shows an embodiment showing backlight control loop,

FIG. 3 shows control loops for control of LEDs,

FIGS. 4 and 5 show views of a backlight topology,

FIG. 6 shows a flow chart of measurement of color, using a monochrome light sensor, and

FIGS. 7 to 10 show views and graphs relating to scanning control.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

References to colour sensors encompass sensors for determining any characteristic of the colour, such as a spectrum, a change in spectrum, a luminance of a given colour, a saturation or intensity or width of a spectral peak of light for example. The term “spectrum” as referred to the frequency range that can be sensed by the sensors, includes the wavelength range 380 nm to 750 nm or 380 nm to 830 nm or a wider range or a subrange thereof. A sensor may comprise one or more sensing devices, e.g. each sensitive to a different wavelength range. For example a sensing device may be sensitive to a part of the spectrum such as the wavelength range 380-450 nm (violet), 450-495 nm (blue), 495-570 nm (green), 570-590 nm (yellow), 590-620 nm (orange), 620-750 nm (red), or combinations of these or subranges of these. Any of the sensors or sensing devices may includes a filter to determine the wavelength range that the sensor senses.

The invention will now be described by a detailed description of several embodiments of the invention. It is clear that other embodiments of the invention can be configured according to the knowledge of persons skilled in the art without departing from the technical teaching of the invention, the invention being limited only by the terms of the appended claims.

### Additional Features:

Embodiments can have any additional features as well as those features set out in the independent claims. Some additional features are as follows:

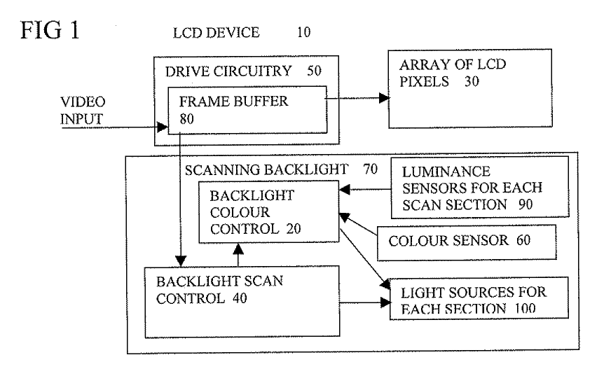

The backlight can have separate luminance sensors for detecting luminance levels of different ones of at least some of the sections, the controller being arranged to control the luminance levels according to outputs of the separate luminance sensors. This can avoid the need for a colour sensor for each section and so can enable reduced costs, by recognizing that luminance typically should be sensed and controlled more actively and rapidly than the colour output. This is described below with regard to FIGS. 1, 4 and 6 at least.

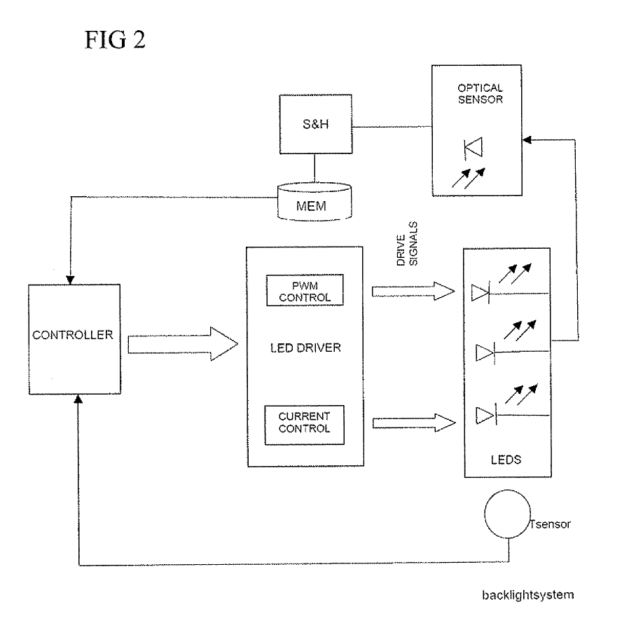

The controller can be arranged to determine and store colour calibration settings using the colour sensor when the backlight is not in use, and to control the luminance levels when the backlight is in use according to the stored colour calibration settings and according to outputs of the separate luminance sensors. This can be useful if the colour sensing needs more time than can be accommodated in brief frame blanking intervals for example. This is described below with regard to FIGS. 2, 3 and 6 at least.

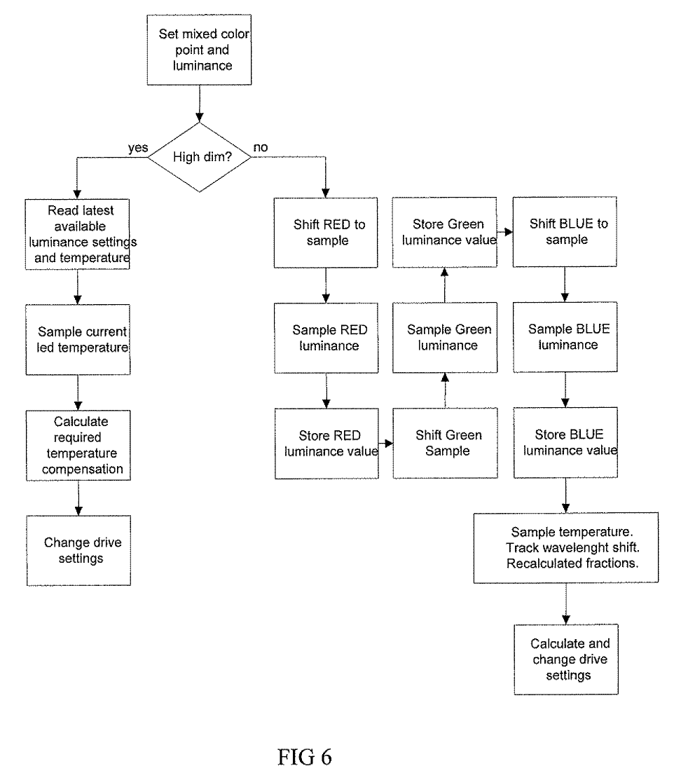

The controller can be arranged to illuminate one of the sections and to detect the spectrum for that section while only that section is illuminated. This is useful to enable colour drift in each section to be detected rapidly. This is described below with regard to FIGS. 2 and 6 at least.

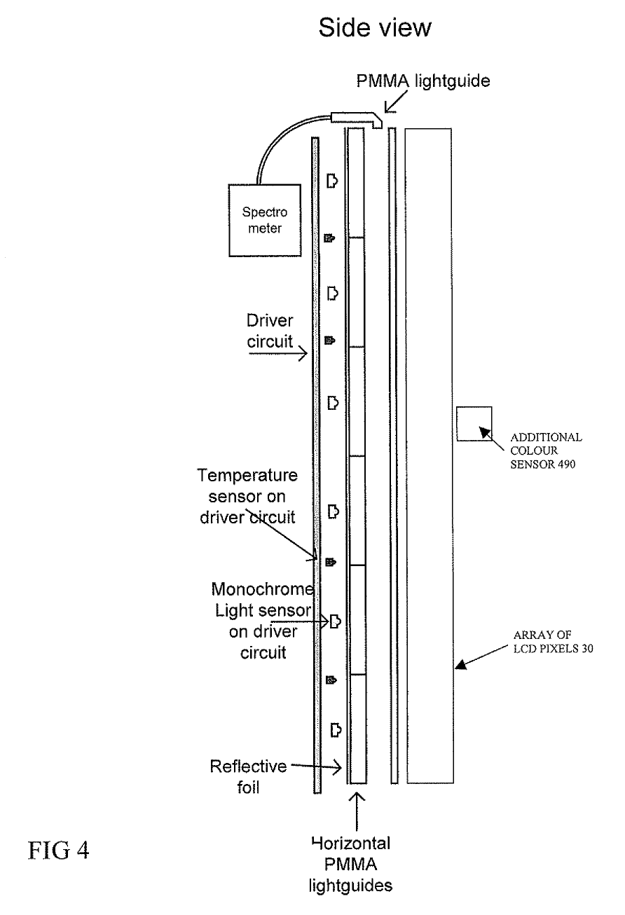

The backlight can be incorporated with a transmissive display panel in an output light path of the backlight, and the colour sensor can be located in a light mixing area between the backlight and the display panel. This is useful to enable the sensing to be independent of colour shifts introduced by the display panel. This is described below with regard to FIGS. 4 and 5 at least.

The backlight can be incorporated with a transmissive display panel in an output light path of the backlight, and can have an additional colour sensor in the light path after the display panel. This is useful to enable compensation of colour shifts introduced by the display panel. This is described below with regard to FIGS. 2 and 4 at least.

The backlight can have multiple light sources of different colours, the controller being arranged to cause a single colour to be on for a period, and to sense its luminance output level at least, at that period. This is useful to enable detection and compensation for overall colour shifts caused by luminance level changes in different colour sources. This is described below with regard to FIG. 6 at least.

The backlight can have multiple colour sensors located in the output light paths of different ones of the sections. This is typically more expensive, but could enable more rapid sensing and simpler control than using a single colour sensor for all sections. This is described below with regard to FIGS. 2 and 4 at least.

The sections can be arranged to have light sources arranged to light their respective section from an edge of the section, the light sources having a number of different colours and a mixing section being provided for mixing the light before it enters the edge of the section, the mixing section having a bend of at least 90 degrees or 120 degrees or 180 degrees. The bend can help enable the mixing to take place in a shorter overall distance, to keep the backlight more compact. This is described below in relation to FIG. 5 at least.

The backlight can be incorporated with a transmissive display panel in an output light path of the backlight, and can have a light mixing area between the backlight and the display panel, the sections being arranged to allow some overlap of light between neighbouring sections in this light mixing area. This can help to make the boundaries between sections less visible to viewers. This is described with regard to FIG. 4 at least.

### FIG. 1: Backlight Incorporated in Display

FIG. 1 shows some of the principal parts of an embodiment of the invention. A scanning backlight 70 is incorporated in a transmissive light valve display such as an LCD device 10. The LCD device has an array of LCD pixels 30, driven by drive circuitry 50. This may include for example a frame buffer 80 or other circuitry, fed by an input video signal for display. The scanning backlight has a backlight scan control part 40 synchronised by an input from the drive circuitry. The scan control drives light sources 100, and also feeds a backlight colour control part 20. The colour control part 20 also influences the output of the light sources. The colour control part 20 is fed by a colour sensor 60, and luminance sensors 90 for each scan section. The luminance sensors can in some embodiments be replaced by one or more colour sensors.

### FIG. 2, Backlight Control Loop

FIG. 2 shows another embodiment of the invention showing parts of the backlight. The light sources are shown in the form of 3 LEDs, typically Red, Green and Blue, to mix into white light. These are driven by an LED driver typically having current control and PWM control parts. There can be separate sets of LEDs and separate drivers for each section (not shown for clarity). The LED driver is controlled by a controller, which is arranged to drive the LEDs, and can control many sections, to achieve a uniform output across sections, and to maintain a desired balance between different colour LEDs to achieve the desired output white. The controller can be fed by a temperature input from a temperature sensor, e.g. as shown. The controller can also be fed by optical sensors such as colour and/or luminance sensors detecting the light output of the LEDs. There can be one or more colour sensors, and in some embodiments there are luminance sensors for each section, or colour sensors for each section. The sensor outputs are fed to a sample and hold device (S and H). The outputs of these sample and hold devices are stored in a memory (MEM), for use by the controller. The timing of the sampling can be synchronized by the controller, to coincide with a single one of the LEDs being driven so that the stored value represents the luminance or colour of a single LED. For optical sensors arranged in the light path of multiple sections, then the controller can be arranged to illuminate only one of the sections at a time, so that the sampled value relates to only one of the sections.

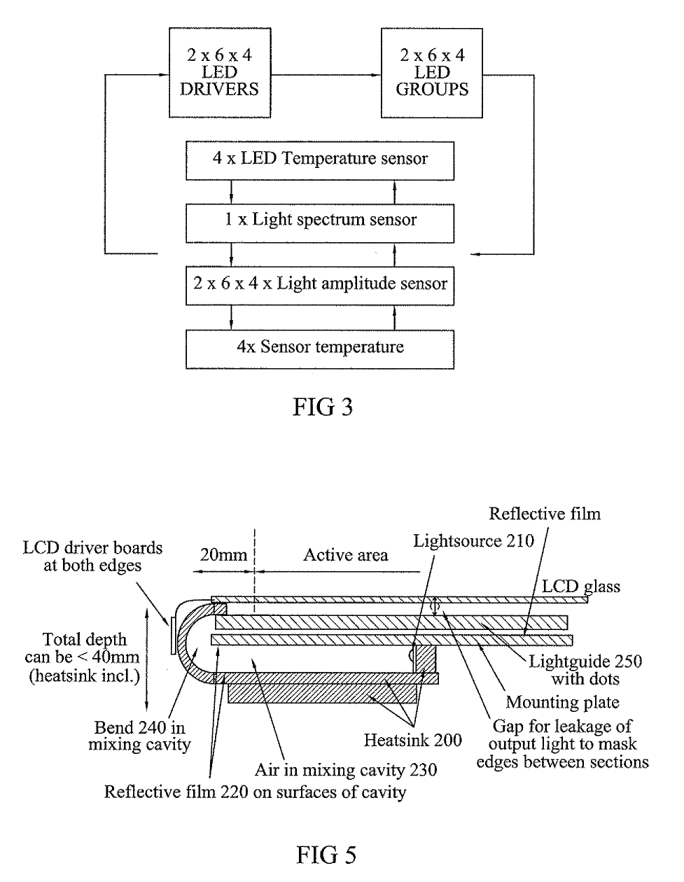

### FIG. 3 Control Loops for Control of LEDs

FIG. 3 shows a schematic view of inter-relationships of control loops for an example having 6 sections. Each section has two sets of 4 light source groups such as LED groups, each consisting of one or more LEDs, one set for each end of a horizontal tray. Hence there are 48 individual LED-circuits. Their outputs can be measured separately by monochrome sensors as will be described in more detail below, measuring the absolute light-power output. This measurement system is compensated with the temperature data gathered by the thermal sensors placed on board, near the optical sensor elements.

There can also be a colour sensor in the form of a spectrometer to provide information on the spectrum of the generated light, such as peak wavelength or colour intensity, allowing the system to compensate for drifts in spectral behavior of the monochrome sensors and for drifts in spectral emission of the LED's. This measurement loop is backed-up by four temperature sensors placed on the LED heat sink.

The unique combination of these different loops is that each provides a check or compensation method for the other loops, allow each to be kept in calibration. Calibration can involve all 6 monochrome light sensors being factory calibrated. A first calibration loop can involve measuring separately the monochrome brightness of N colors of each of the M trays (=N×M measurements), which in the example shown represents measuring all 3 colors of all 6 trays (=18 measurements). This can be carried out by illuminating different LEDs separately using the time-shift method as described below.

Based on the measurements, the PWM control level of the LED drivers is then carried out, to ensure a uniform backlight.

This can include taking account of any non linear relationship between what the eye perceives and light power.

A second calibration loop involves the sensor of the spectrum. This measures spectral or chromatic characteristics of light, e.g. integrated over a longer time. On the basis of these measurements, a global PWM drive level adjustment can be made, and video 3×3 matrices for generating RGB values from the video input, can be adjusted to ensure exact color triangle matching.

### FIGS. 4 and 5; Backlight Topology

FIG. 4 shows a side view of a backlight topology according to an embodiment. Each section has a horizontal lightguide such as a PMMA lightguide. They are edge lit by a light source arranged with a folded mixing path having a 180 degree bend to enable a notably thin backlight. Other bending arrangements can be envisaged, such as a 70 to 90 degree bend in the main plane of the device. It can combine a long inherent mixing length with as a consequence, a high luminance and color uniformity. Above that the construction allows horizontal partitioning of the light paths to provide sections. A scanning backlight drive scheme is incorporated.

Each section has its own light sensor on the LED driver circuit. A temperature sensor is shown on the driver circuits. A spectrometer is shown located at the back of the device, fed by a light path in the form of a lightguide for example or any other suitable light path such as provided by a mirror. Optionally an additional spectrum sensor 490 is shown on the far side of the array 30 of LCD pixels.

An additional light mixing area is added between the front of the lightguides and the rear of the LCD panel with its optical foils. This extra mixing volume has a twofold function:

Firstly it introduces additional light mixing between lightrays from the edges of any 2 neighbour lightguide-trays such that the gap between these trays is not visible when looking from the front of the LCD panel.

Secondly this area provides also the space needed for positioning an extra t sensor that will measure the light output from the individual lightguide trays, this in order to adapt via a feedback loop intensity and color point such that the required uniformity can be achieved.

FIG. 5 shows a top or bottom view of a section of the embodiment of FIG. 4. This shows the PMMA lightguide with a bend, mounted on a mounting plate. At one end of this is the lightsource such as an LED, and its corresponding heatsink. A gap is shown between the backlight and the facing glass plate of the light valve array, erg. LCD array. A fixation or spacer bar is shown to maintain this gap. Another optional fixation bar is shown to fix the light guide to the mounting plate. Drive circuitry for the LCD array can be located optionally at the edges, and drive circuitry for the LEDs can be located optionally on the back of the device. Other arrangements can be envisaged. A typical total depth can be around 40 mm including heatsinks and a 20 mm blank area can be provided as a frame around the active area but these are only examples. Clearly these dimensions are examples and other dimensions can be used.

### FIG. 6. Flow Chart of Measurement of Color, Using a Monochrome Light Sensor

FIG. 6 shows a flow chart for a measurement and control process. By using pulsed operation of the light sources of the backlight, a black timeslot of about X μs, M times every frame (e.g. at 120 Hz) for example, is created. By shifting 1 of the N colors of a specific tray X μs to the right, this color will be the ONLY light generated in the complete backlight during this X μs timeslot. This makes it possible, using a monochrome light sensor mounted on that specific tray, to measure the light coming from only that tray. X can be 200 for example, or other value as desired. M can be 6 or other value, N is typically 3 but can be other values as desired.

Initially as shown, a mixed colour point and luminance is set. Next the flow chart divides according to whether a high level of dimming is needed. For little dimming, a first step is to shift Red to the sampling timeslot. Red luminance is sampled and stored. This is repeated for Green, then Blue, though a different order can be used. Temperature is then sampled, wavelength shift for that temperature is determined, and RGB drive values are recalculated and used.

For a high dimming scenario, there is less time available for the shifting as the backlight is not on for so much time. Latest available luminance settings and temperature are read, LED temperature is sampled. Required temperature compensation is calculated, and change drive settings accordingly.

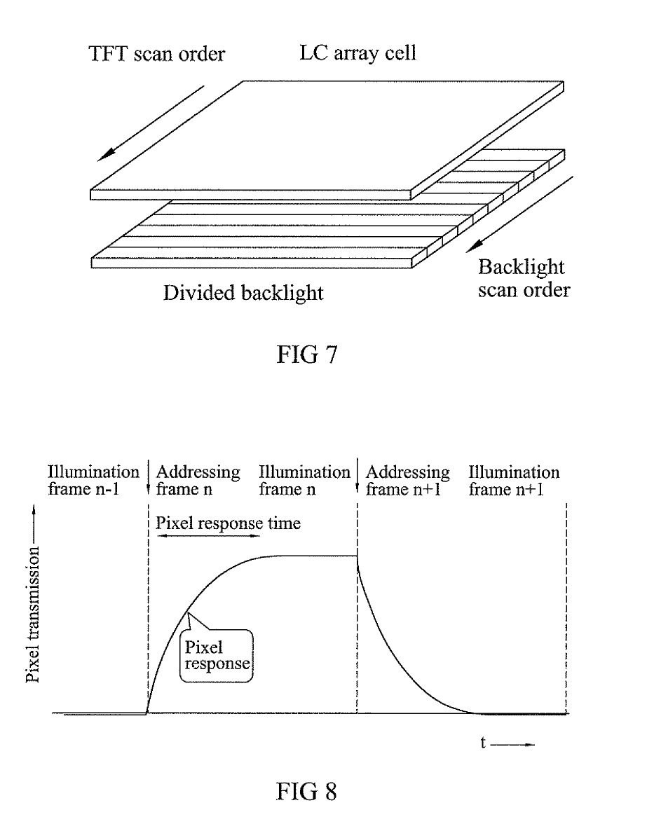

### FIGS. 7 to 10; Scanning Control

FIG. 7 shows the backlight and the array of liquid crystal elements. In this view, the directions of scanning of the array and the backlight are shown.

FIG. 8 shows for an individual pixel in a light valve array, such as an LCD array, a pixel response curve indicating a pixel transmission level over time. In a first addressing frame time, there is an upward curve labeled as the pixel response time, followed by a flat region for the rest of the frame time, marked as the illumination frame. This unshaded region can indicate a time when the backlight is illuminated. The next frame can be a black insertion time, in which case the pixel is driven to a black level during an addressing frame and remains there for the subsequent illumination frame.

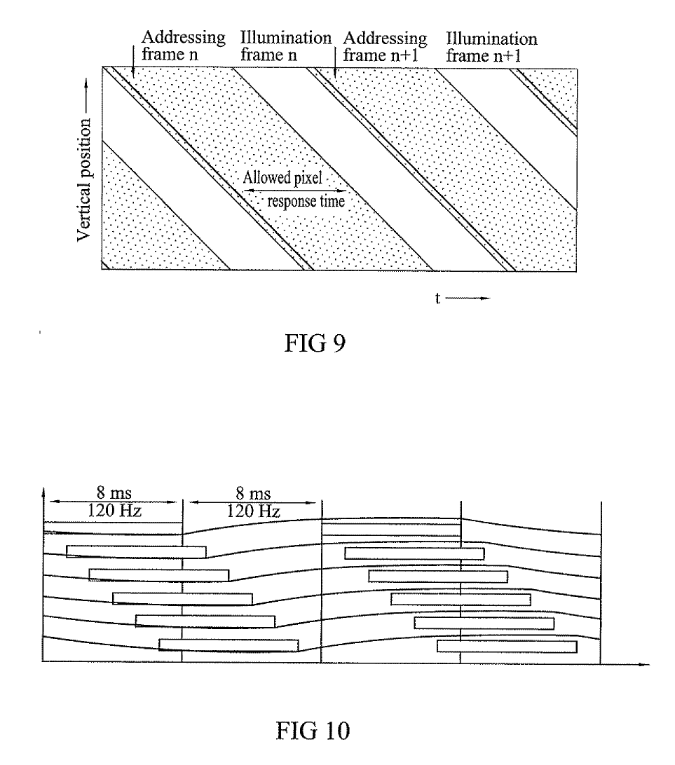

FIG. 9 shows a graph of frame delays relative to vertical position of a given pixel. It shows how with vertical position of the pixel, the illumination frame and addressing frames are delayed by different amounts in accordance with a scanning scheme.

FIG. 10 shows a similar view for delay relative to vertical position of different trays of a backlight. The lines show a response of an individual pixel at the top of the respective tray. The rectangles show times when the tray is lit. It shows how there is a corresponding relative delay between trays according to a vertical position of the tray.

Control of Luminance and/or Colour

Embodiments of the backlight system can comprise a plurality of coloured light-emitting diodes (LEDs) of different colours, such as LEDs of three colours, e.g. red, green and blue (RGB) LEDs. The plurality of LEDs may be combined into a plurality of colour channels, e.g. in the example given above a red, a green and a blue colour channel. The LEDs may be arranged in a planar matrix functioning as a backlight for an instrument display, such as an LCD display. The LCD is translucent and some of the light generated by the LED matrix behind the LCD display passes through the display, illuminating the display. Such display arrangements may be used in avionics or vehicular applications, but also in desktop applications, requiring varying backlight levels for example.

The LEDs are controlled by a LED driver generating control signals such as e.g. a drive current control signal and a pulse width modulation (PWM) control signal. The drive current control signal controls the current flowing through the LEDs. The PWM control signal controls the power to the LEDs. The combination of the drive current control signal and the PWM control signal to an LED determines the ON time and the emitted luminance of the LEDs.

The LED driver itself is preferably controlled by a controller. The controller may include a digital processing or computing device, e.g. a microprocessor, for instance it may be a micro-controller. In particular, it may include a programmable LED driver controller, for instance a programmable logic device such as a Programmable Array Logic (PAL), a Programmable Logic Array (PLA), a Programmable Gate Array (PGA), especially a Field Programmable Gate Array (FPGA). The controller may be programmed by suitable software that carries out any of the methods of the present invention. In particular the software may include code that executes a method for controlling an illumination system comprising a plurality of coloured light sources, there being at least one or more light sources of a first colour and one or more light sources of a second colour, the first colour being different from the second colour, the illumination system being for emitting illumination light when executed on a suitable processing device.

The software may include software for determining first drive settings for each of the plurality of coloured light sources so as to provide illumination light with a pre-determined colour point and/or a pre-determined luminance, the first drive settings generating an ON time and an OFF time of the light sources, for the light sources of the first colour, changing the first drive settings so that the ON time of the light sources of the first colour does not coincide with the ON time of the light sources of the other colours for at least a period of time, during that period of time, measuring the peak luminance of the light sources of the first colour, based on the measured peak luminance for the light sources of the first colour, recalculating the drive settings into second drive settings so as to maintain pre-determined colour point, and repeating the above steps for at least the light sources of the second colour.

The software may also include code whereby the first drive settings comprise current control and pulse width modulation control. The software may also include code for directly or indirectly measuring temperature of the coloured light sources.

The controller may store calibration values of all colours such as luminance at full duty, temperature, colour, mixed colour set point.

The optical sensor may be a photodiode. The optical sensor may be any sensor that covers a spectral range of interest, depending on the light sources in the illumination system, e.g. a sensor that covers the visible spectral range. The optical sensor may e.g. have a spectral range from 400 to 700 nm. The optical sensor may be placed in the backlight cavity. Using such single sensor rather than using a plurality of dedicated colour sensors alleviates the use of expensive optical filters to be used for the sensor, and thus reduces the cost of the system. Using a single circuit furthermore prevents differential ageing.

Optionally, the backlight system in accordance with embodiments of the present invention may also be provided with a temperature sensor, for sensing the temperature of the LEDs.

The controller reads out from the sensors the optical sensor value and optionally ambient conditions such as LED temperature. Based on these measurements, and by comparing the sensed luminance with the pre-determined or desired luminance, correction values for the drive signals to the LEDs are determined. This is done during real-time, i.e. measurements are made and corrections to the drive signals are applied while the light source is in use for a real application. With “in use for a real application” is meant, e.g. for a backlit display, while data content is being displayed to a user, rather than during calibration or during setting-up of the display system. The corrections are so as to obtain a controlled colour point and/or luminance of the light source, e.g. backlight.

Ambient light may furthermore also be measured by means of an ambient light sensor (not illustrated), in order to determine the amount of dimming required, or thus the desired luminance.

If the duty cycle is high enough, i.e. if the pulse width of the shortest colour pulse is larger than the addition of the response time of the sensor and the sample time, i.e. at low dimming and thus at high brightness, the system selects a first colour to measure the luminance, e.g. RED. In order to be able to measure the RED, the driving of the RED is shifted in time from the GREEN and the BLUE so that the RED light source (or the light sources of the red colour channel) is (are) energised or driven at a moment in time when the other, e.g. GREEN and BLUE, light sources are not driven. The first light source is thus driven separately from the other light sources. Because the peak value of the luminance is measured, this shift time can be very short (response time of the sensor). In one example, the shift time has a length of 5 μs. After the value is stable (depending on the response time of the optical sensor, in the example given about 2 μs), a sample and hold circuit saves the luminance value in a memory. This sample and hold action requires about 2 to 3 μs. The moment the luminance value is sampled, there is no interference from the other colours, so a clear luminance value for the particular colour can be obtained, without interference from the other colours present in the backlight.

From the measured value stored in a memory, the controller calculates the drive settings (current control signal and PWM control signal) to maintain the desired mixed colour point, e.g. white colour point. One of the colours is used as reference to regulate the mixed colour luminance.

A temperature sensor may be provided for sensing the temperature of the LEDs. Based on the measured temperature, a wavelength shift of the colour LEDs may be tracked to by means of look-up tables indicating wavelength shift in function of temperature. The fractions of the colours are then recalculated by using new x,y-coordinates for the colours which have wavelength shifted, and these recalculated fractions are used as input for the luminance compensation. Calculation of such fractions is exemplified below. This sequence is repeated continuously or quasi-continuously for each colour. Furthermore, in an alternative embodiment, the measurement of all colours may be intermixed with a luminance measurement performed at a moment in time when none of the colour channels are energised. This measures the offset value of the optical sensor, i.e. the luminance sensed when a value for black should be obtained, which offset value can be subtracted from the measured luminance values for the colour channels in order to obtain more accurate measurement values.

Because the PWM control signals are generated by the controller and peak luminance values are measured, the luminance can be calculated and regulated to the desired or required colour point, e.g. white point. This system does not require any recalibration or initiated calibration step to regulate the desired colour point, e.g. white point, over lifetime. Also, because only one sensor is used, there is no variation between the colour measurements (same response, same temperature behaviour, no differential ageing, etc.) which is a big advantage for colour stability and robustness of the system over lifetime and temperature range.

As an example, if the pulse width modulation has a frequency of 180 Hz, one pulse width period has a duration of 5.5 ms. If an optical sensor is used with a response time of 2 μs, and the sample time is 3 μs, then the shift time over which the driving of a selected colour for measurement purposes needs to be shifted is 5 μs. Therefore, the dimming ratio is about 1100:1. For the same sensor, if a pulse width modulation with a frequency of 90 Hz is used, the dimming ratio is about 2200:1. The shift time is about 0.01% of the PWM period.

Furthermore, for high dimming applications, embodiments can provide temperature compensation. If the luminance/duty cycle is very low, high dimming occurs. If the dimming ratio is higher than the response time of the sensor, PWM pulses are too short to be sampled, and the feedback system in accordance with embodiments of the present invention may be provided with switching means to switch the control to a temperature control algorithm based on lookup tables and the last luminance measurements. The system can automatically switches to temperature compensation based on the latest luminance values measured during high brightness or thus low dimming mode. The measured luminance and temperature values are used to calculate the driver settings to maintain the programmed colour point.

At this moment in time, as the temperature feedback is only used when almost no power is in the LED, the temperature of the LED can easily be determined by determining the LED die temperature. Typical power LEDs have a temperature drop ΔT (die−solder point) of 10K/W but if the duty cycle is > 1/2000 the temperature drop ΔT is negligible and the board temperature can be measured to know the LED die temperature. Depending on the used LED, technology dimming ratios of more than 15000:1 are possible.

Embodiments of the present invention can comprise control software in the form of a computer program product which provides the desired functionality when executed on a computing device, e.g. the controller. Further, the present invention includes a data carrier such as a CD-ROM or a diskette which stores the computer product in a machine readable form and which executes at least one of the methods of the invention when executed on a computing device. Nowadays, such software is often offered on the Internet or a company Intranet for download, hence the present invention includes transmitting the computer product according to the present invention over a local or wide area network. The computing device may include one of a microprocessor and an FPGA.

As an example only, the needed fractions f_{R}, f_{G}, f_{B} of RED, GREEN and BLUE flux respectively, with given RED, GREEN and BLUE xy-coordinates (x_{R}, y_{R}), (x_{G}, y_{G}), (x_{B}, y_{B}), are calculated hereinafter, in order to produce a given 9000K white point, with given xy-coordinates (x_{W}, y_{W}).

In general, the needed fractions of the light sources are expressed in function of the xy-coordinates of the available RED, GREEN and BLUE light sources and in function of the xy-coordinates of the white point as follows:

$$( \begin{matrix}{f}_{R} \\ {f}_{G} \\ {f}_{B}\end{matrix} ) = {( \begin{matrix}\frac{{x}_{R}}{{y}_{R}} & \frac{{x}_{G}}{{y}_{G}} & \frac{{x}_{B}}{{y}_{B}} \\ 1 & 1 & 1 \\ \frac{1 - {x}_{R} - {y}_{R}}{{y}_{R}} & \frac{1 - {x}_{G} - {y}_{G}}{{y}_{G}} & \frac{1 - {x}_{B} - {y}_{B}}{{y}_{B}}\end{matrix} )}_{{↔}_{Part A}} {{}^{- 1} ( \begin{matrix}\frac{{x}_{W}}{{y}_{W}} \\ 1 \\ \frac{1 - {x}_{W} - {y}_{W}}{{y}_{W}}\end{matrix} )}_{{↔}_{Part B}}$$

The explicit form of the inverse matrix is as follows:

$${A}^{- 1} = ( \begin{matrix}\frac{( \begin{matrix}( - 1 + {x}_{G} ) {y}_{B} - \\ ( - 1 + {x}_{B} ) {y}_{G}\end{matrix} ) {y}_{R}}{\begin{matrix}\begin{matrix}{x}_{R} ( - {y}_{B} + {y}_{G} ) + \\ {x}_{G} ( {y}_{B} - {y}_{B} ) +\end{matrix} \\ {x}_{B} ( - {y}_{G} + {y}_{R} )\end{matrix}} & \frac{( \begin{matrix}- {x}_{G} ( - 1 + {y}_{B} ) + \\ {x}_{B} ( - 1 + {y}_{G} )\end{matrix} ) {y}_{R}}{\begin{matrix}\begin{matrix}{x}_{R} ( {y}_{B} + {y}_{G} ) + \\ {x}_{B} ( {y}_{G} - {y}_{R} ) +\end{matrix} \\ {x}_{G} ( - {y}_{B} + {y}_{R} )\end{matrix}} & \frac{( \begin{matrix}{x}_{G} {y}_{B} - \\ {x}_{B} {y}_{G}\end{matrix} ) {y}_{R}}{\begin{matrix}\begin{matrix}{x}_{R} ( - {y}_{B} + {y}_{G} ) + \\ {x}_{G} ( {y}_{B} - {y}_{B} ) +\end{matrix} \\ {x}_{B} ( - {y}_{G} + {y}_{R} )\end{matrix}} \\ - \frac{{y}_{G} ( \begin{matrix}( - 1 + {x}_{R} ) {y}_{B} - \\ ( - 1 + {x}_{B} ) {y}_{R}\end{matrix} )}{\begin{matrix}\begin{matrix}{x}_{R} ( - {y}_{B} + {y}_{G} ) + \\ {x}_{G} ( {y}_{B} - {y}_{R} ) +\end{matrix} \\ {x}_{B} ( - {y}_{G} + {y}_{R} )\end{matrix}} & \frac{{y}_{G} ( \begin{matrix}- {x}_{R} ( - 1 + {y}_{B} ) + \\ {x}_{B} ( - 1 + {y}_{R} )\end{matrix} )}{\begin{matrix}\begin{matrix}{x}_{R} ( - {y}_{B} + {y}_{G} ) + \\ {x}_{G} ( {y}_{B} - {y}_{R} ) +\end{matrix} \\ {x}_{B} ( - {y}_{G} + {y}_{R} )\end{matrix}} & - \frac{{y}_{G} ( \begin{matrix}{x}_{R} {y}_{B} - \\ {x}_{B} {y}_{R}\end{matrix} )}{\begin{matrix}\begin{matrix}{x}_{R} ( - {y}_{B} + {y}_{G} ) + \\ {x}_{G} ( {y}_{B} - {y}_{R} ) +\end{matrix} \\ {x}_{B} ( - {y}_{G} + {y}_{R} )\end{matrix}} \\ - \frac{{y}_{B} ( \begin{matrix}( - 1 + {x}_{R} ) {y}_{G} - \\ ( - 1 + {x}_{G} ) {y}_{R}\end{matrix} )}{\begin{matrix}\begin{matrix}{x}_{R} ( {y}_{B} - {y}_{G} ) + \\ {x}_{B} ( {y}_{G} - {y}_{R} ) +\end{matrix} \\ {x}_{G} ( - {y}_{B} + {y}_{R} )\end{matrix}} & \frac{{y}_{B} ( \begin{matrix}- {x}_{R} ( - 1 + {y}_{G} ) + \\ {x}_{G} ( - 1 + {y}_{R} )\end{matrix} )}{\begin{matrix}\begin{matrix}{x}_{R} ( {y}_{B} - {y}_{G} ) + \\ {x}_{B} ( {y}_{G} - {y}_{R} ) +\end{matrix} \\ {x}_{G} ( - {y}_{B} + {y}_{R} )\end{matrix}} & - \frac{{y}_{B} ( \begin{matrix}{x}_{R} {y}_{G} - \\ {x}_{G} {y}_{R}\end{matrix} )}{\begin{matrix}\begin{matrix}{x}_{R} ( {y}_{B} - {y}_{G} ) + \\ {x}_{B} ( {y}_{G} - {y}_{R} ) +\end{matrix} \\ {x}_{G} ( - {y}_{B} + {y}_{R} )\end{matrix}}\end{matrix} )$$

If, for R, G and B LEDs of a light source, with given colour coordinates:

x_{R}=0.700, y_{R}=0.299
x_{G}=0.206, y_{G}=0.709
x_{B}=0.161, y_{B}=0.020
the R, G and B flux fractions needed to produce 9000K white light with
x_{W}=0.287 and y_{W}=0.296
are to be calculated, then substituting the x and y values of RED, GREEN and BLUE LEDs results in the numerical matrix:

$$A = ( \begin{matrix}2.3411 & 0.2906 & 8.0500 \\ 1.0000 & 1.0000 & 1.0000 \\ 0.0033 & 0.1199 & 40.9500\end{matrix} )$$

The inverse of this matrix is.

$${A}^{- 1} = ( \begin{matrix}0.4825 & - 0.1292 & - 0.0917 \\ - 0.4838 & 1.1325 & 0.0675 \\ 0.0014 & - 0.0033 & 0.0242\end{matrix} )$$

Substituting the x_{W} and y_{W} coordinates of the white point results in the column vector:

$$B = ( \begin{matrix}0.9696 \\ 1.0000 \\ 1.4088\end{matrix} )$$

Finally, multiplying the inverted matrix by the column vector, results in the flux fractions:

$$( \begin{matrix}{f}_{R} \\ {f}_{G} \\ {f}_{B}\end{matrix} ) = A ⊗ B = ( \begin{matrix}0.2094 \\ 0.7584 \\ 0.0322\end{matrix} )$$

Or stated in words: to produce 1 lm of white light (9000K) with coordinates (x_{W}, y_{W})=(0.287, 0.297) with the above-mentioned RED, GREEN and BLUE LEDs, the following fractions are needed:

### RED=0.21 lm

### GREEN=0.76 lm

### BLUE=0.03 lm

It is to be understood that although preferred embodiments, specific constructions and configurations, as well as materials, have been discussed herein for devices according to the present invention, various changes or modifications in form and detail may be made without departing from the scope and spirit of this invention. For example, any formulas given above are merely representative of procedures that may be used. Functionality may be added or deleted from the block diagrams and operations may be interchanged among functional blocks. Steps may be added or deleted to methods described, and other variations can be envisaged within the scope of the claims.

1. A scanning backlight for a display, comprising:
a number of backlight sections separately illuminated,
a color sensor adapted to detect a spectrum of the illumination, and
a controller arranged to control:
the illuminating of the different sections at different times;
relative luminance level of each of the different sections; and
a color of the illuminations of the different sections according to the spectrum detected by the color sensor.

2. The backlight of claim 1, including separate luminance sensors that detect luminance levels of different ones of at least some of the sections, the controller being arranged to control the luminance levels according to outputs of the corresponding separate luminance sensors.

3. The backlight of claim 1, the controller being arranged to determine and store color calibration settings using the color sensor when the backlight is not in use, and to control the luminance levels when the backlight is in use according to the stored color calibration settings and according to outputs of the separate luminance sensors.

4. The backlight of claim 1, wherein the controller is arranged to illuminate one of the sections and to detect the spectrum for that section while only that section is illuminated.

5. The backlight of claim 1, including multiple light sources of different colors, the controller being arranged to cause a single color to be on for a predetermined period, and to sense the luminance output level of the multiple light sources at least at that period.

6. The backlight of claim 1, including multiple color sensors located in the output light paths of different ones of the sections.

7. The backlight of claim 1, the sections having light sources arranged to light their respective section from an edge of the section, the light sources having a number of different colors and a mixing section for mixing the light before it enters the respective edge of each section, the mixing section having a bend of at least 70 degrees.

8. A display comprising the backlight of claim 1.

9. The display of claim 8, comprising a transmissive display panel in an output light path of the backlight, wherein the color sensor is located in a light mixing area between the backlight and the display panel.

10. The display of claim 8, including a transmissive display panel in an output light path of the backlight, and including an additional color sensor in the light path after the is display panel.

11. The display of claim 8, including a transmissive display panel in an output light path of the backlight, and a light mixing area between the backlight and the display panel, the sections being arranged to allow some overlap of light between neighbouring sections in the light mixing area.

12. A method of controlling a scanning backlight, the backlight having a number of sections separately illuminated, and the backlight having a color sensor arranged to detect a spectrum of the lighting, the method comprising the steps:
controlling the illuminating of the different sections at different times;
controlling relative luminance levels of the different sections; and
controlling a color of the illuminations of the different sections according to the detected spectrum.

13. A computer program comprising code on a computer readable medium for execution by a computer to carry out the method of claim 12.
